(19) United States
(12) Patent Application Publication
(10) Pub. No.: US 2018/0054572 A1
(43) Pub. Date: Feb. 22, 2018

(54) CONTROL DEVICE, IMAGING DEVICE, MOBILE OBJECT, CONTROL METHOD AND PROGRAM

(71) Applicant: SZ DJI TECHNOLOGY CO., LTD., Shenzhen (CN)

(72) Inventor: Atsuo MINATO, Tokyo (JP)

(21) Appl. No.: 15/784,692

(22) Filed: Oct. 16, 2017

Related U.S. Application Data
(63) Continuation of application No. PCT/JP2016/067553, filed on Jun. 13, 2016.

(51) Int. Cl. H04N 5/232; B64C 39/02; B64D 47/08

(52) U.S. Cl. CPC H04N 5/23296; H04N 5/23203; B64C 2201/127; B64D 47/08; B64C 39/024

(57) ABSTRACT

A control device can include an acquisition unit and a control unit. The acquisition unit can acquire information that indicates at least one of a mass or a center of gravity position of an optical device having one or more lens. The control unit can control an attitude of the optical device based on the at least one of the mass or the center of gravity position indicated in the information acquired by the acquisition unit.

### CROSS-REFERENCE TO RELATED APPLICATION

This is a continuation application of PCT Application No. PCT/JP2016/067553, filed on Jun. 13, 2016, the entire contents of which are incorporated herein by reference.

### FIELD

The disclosed embodiments relate to control devices, imaging devices, mobile objects, control methods, and programs.

### BACKGROUND

A television camera device is disclosed in patent literature 1. A handle-attached seat can be attached on the upper portion of the camera unit of the television camera device. A handle lower end portion that can slide in a groove of the handle-attached seat can be formed on the handle. As a result, deterioration in handle balance can be suppressed even while moving the center of gravity of the camera.

Patent Literature 1 Japanese Patent Application Publication No. 2007-335990

### SUMMARY

There are sometimes demands to appropriately control the attitude of an optical device based on at least one of the weight or the center of gravity of the optical device.

In one aspect, a control device can include an acquisition unit and a control unit. The acquisition unit can acquire information that indicates at least one of the mass or the center of gravity position of an optical device having one or more lens. The control unit can control the attitude of the optical device based on at least one of the mass or the center of gravity position indicated in information acquired by the acquisition unit.

The acquisition unit can acquire information that indicates the mass and the center of gravity position of the optical device. The control device can control the attitude of the optical device based on the mass and the center of gravity position of the optical device indicated in information acquired by the acquisition unit.

Information that indicates a plurality of center of gravity positions of the optical device can be acquired, corresponding to a plurality of respective positions of movable lenses from among one or more lens.

The plurality of center of gravity positions of the optical device can correspond to a plurality of respective focal distances of the optical device.

The plurality of center of gravity positions of the optical device can correspond to a plurality of respective focus positions of the optical device.

A measurement unit for measuring the center of gravity position of the optical device can be further provided. The acquisition unit can acquire information that indicates a first center of gravity position and a second center of gravity position. The first center of gravity position is the center of gravity position of the optical device measured by the measurement unit when the movable lens is in a first position. The second center of gravity position is the center of gravity position of the optical device measured by the measurement unit when the movable lens is in a second position.

The optical device can be held with the ability to rotate centrally around a rotational axis. The measurement unit can measure a first center of gravity position and a second center of gravity position when the rotation angle around the rotational axis of the optical device is a first angle. It can measure the first center of gravity position and the second center of gravity position when the rotation angle around the rotational axis of the optical device is at a second angle.

The optical device can be detachable from the control device. The optical device can be rotatably held with the rotational axis of a direction different from the gravitational direction as the center. The measurement unit can measure an external force applied on the optical device in a first state in which the optical device is not mounted on the control device and a second state in which the optical device is mounted on the control device. It can also measure the center of gravity position of the optical device based on the external force in the first state and the external force in the second state.

The optical device can be detachable from the control device. The control device can further include a storage unit for storing center of gravity position information that indicates the center of gravity position of the optical device measured by the measurement unit and associating it with identification information of the optical device. The acquisition unit can calculate the center of gravity position of the optical device based on the center of gravity position indicated by the center of gravity position information stored in the storage unit and associates it with identification information of the optical device mounted to the control device.

The optical device can be detachable from the control device. The optical device can have a storage unit for storing information that indicates at least one of the mass or the center of gravity position of the optical device. The acquisition unit can acquire information that indicates at least one of the mass or the center of gravity position of the optical device from the optical device mounted on the control device.

The storage unit can store information that indicates an actual measured value of the center of gravity position of the optical device. The acquisition unit can acquire information that indicates an actual measured value of the mass and the center of gravity position of the optical device from the optical device mounted on the control device.

The storage unit can store information that indicates the mass and the center of gravity position of the optical device. The acquisition unit can acquire information that indicates the mass and the center of gravity position of the optical device from the optical device mounted on the control device.

The acquisition unit can acquire information that indicates the center of gravity position of the optical device from the optical device by communicating with the optical device when the optical device is mounted on the control device.

The optical device can be detachable from the control device. The control device can further include a storage unit for associating classifications of a plurality of optical devices with identifying classification information and storing information that indicates at least one of the mass or the center of gravity position of the optical devices of each respective classification. The acquisition unit can acquire information that indicates at least one of the mass or the center of gravity position stored in the storage unit and associates it with classification information of the optical device mounted on the control device.

The control unit can control the attitude of the optical device based on a desired value of the attitude of the optical device, a detected value of the attitude of the optical device, and the attitude of the optical device estimated based on the information acquired by the acquisition unit.

The optical device can further have an imaging unit for capturing an image formed by one or more lens.

In one aspect, an imaging device can include the control device described above and an imaging unit for capturing an image formed by one or more lens.

The one or plurality of lenses can be included in an interchangeable lens that is detachable from the imaging unit.

In one aspect, in a mobile object provided with the control device, an acquisition unit can acquire information that indicates at least one of the mass or the center of gravity position of the optical device during a period from a time when power is applied to the mobile object until a time when the mobile object begins moving.

A drive unit, a detection unit and a verification unit can be further provided. The drive unit can move the mobile object. The detection unit can detect the state of the mobile object or the state around the mobile object. The verification unit can verify an operation verification of the drive unit and detection unit can be further provided. The acquisition unit can acquire information that indicates at least one of the mass or the center of gravity position of the optical device while the verification unit is executing the operation verification.

A step for acquiring information that indicates at least one of the mass or the center of gravity position of the optical device having one or more lens, and a step for controlling the attitude of the optical device based on at least one of the mass or the center of gravity position indicated by the acquired information may be provided.

In one aspect, a program executes the control method in a computer.

The features described above can also be arranged into a variety of sub-combinations.

### BRIEF DESCRIPTION OF THE DRAWINGS

FIG. 1 illustrates a configuration of a system.

FIG. 2 illustrates a function block of a UAV 100.

FIG. 3 illustrates when an optical device 190 is held in a reference attitude.

FIG. 4 illustrates a distance hy until a center of gravity position G from a yaw axis.

FIG. 5 illustrates a format of first center of gravity position information stored in a memory 106 of the UAV body 101.

FIG. 6 illustrates a format of second center of gravity position information stored in the memory 106 of the UAV body 101.

FIG. 7 illustrates a format of third center of gravity position information illustrating a center of gravity position of a lens device 160.

FIG. 8 illustrates when the lens device 160 is not mounted to an imaging unit 140.

FIG. 9 illustrates a process for calculating hp from the center of gravity position of the lens device 160.

FIG. 10 is a flowchart illustrating center of gravity position measurement procedures, in which hp and hy are measured.

FIG. 11 illustrates a format of fourth center of gravity position information stored in the UAV body 101 in another embodiment.

### DETAILED DESCRIPTION OF THE EMBODIMENTS

The present disclosure is described below using embodiments of the disclosure, but the embodiments below do not limit the disclosure according to the scope of the claims. All combinations of features described in the embodiments are not necessary for the means to solve the disclosure.

The scope of the claims, specification, drawings, and abstract include matters subject to protection by copyright. The owner of copyright does not raise objections to duplication by any person of these documents if it is as displayed in files or records of the Patent Office. However, all copyright is retained in other cases.

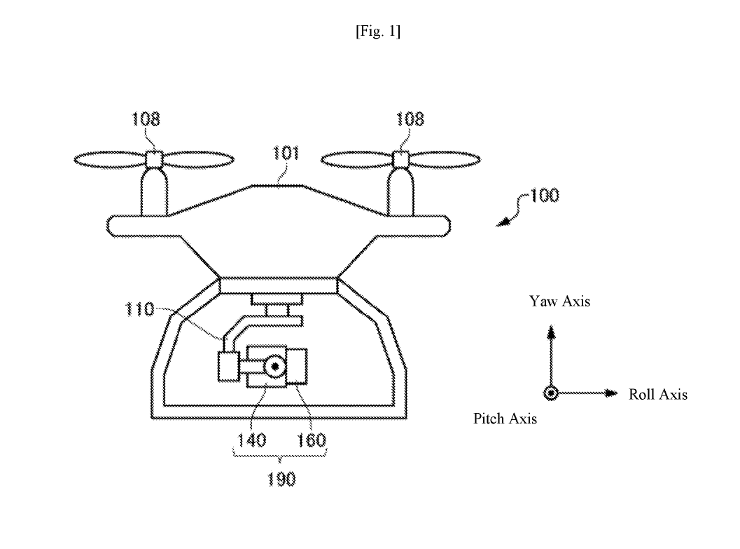

FIG. 1 is an exemplary diagram of a configuration of a system. The system can include an unmanned aerial vehicle (UAV) 100. The UAV 100 can include a UAV body 101, a plurality of rotary wings 108, a gimbal 110, and an optical device 190. The optical device 190 can include an imaging unit 140 and a lens device 160. The UAV 100 is an example of a mobile object provided with a subject. A mobile object can be a concept including other aerial vehicles that move through the air, vehicles that move on the ground, ships that move on the water, etc. in addition to UAV. The optical device 190 can function as an imaging device.

The UAV 100 can fly by controlling the rotation of the plurality of rotary wings 108. The UAV 100 can fly using, for example, four rotary wings. The number of rotary wings 108 is not limited to four. The UAV 100 can be a fixed-wing aircraft that does not have rotary wings 108.

The gimbal 110 can support the imaging unit 140 and lens device 160 so that the attitude of the imaging unit 140 and lens device 160 to the gimbal 110 can be changed. The gimbal 110 can rotatably support the imaging unit 140 and the lens device 160 with at least one axis as the center. For example, the gimbal 110 rotatably supports the imaging unit 140 and the lens device 160 with a respective pitch axis, roll axis, and yaw axis as the center. The gimbal 110 can hold the imaging unit 140, and can hold the lens device 160.

The imaging unit 140 can generate and record image data of an optical image formed via the lens device 160. The lens device 160 can be a so-called interchangeable lens. The lens device 160 can be detachable from the imaging unit 140.

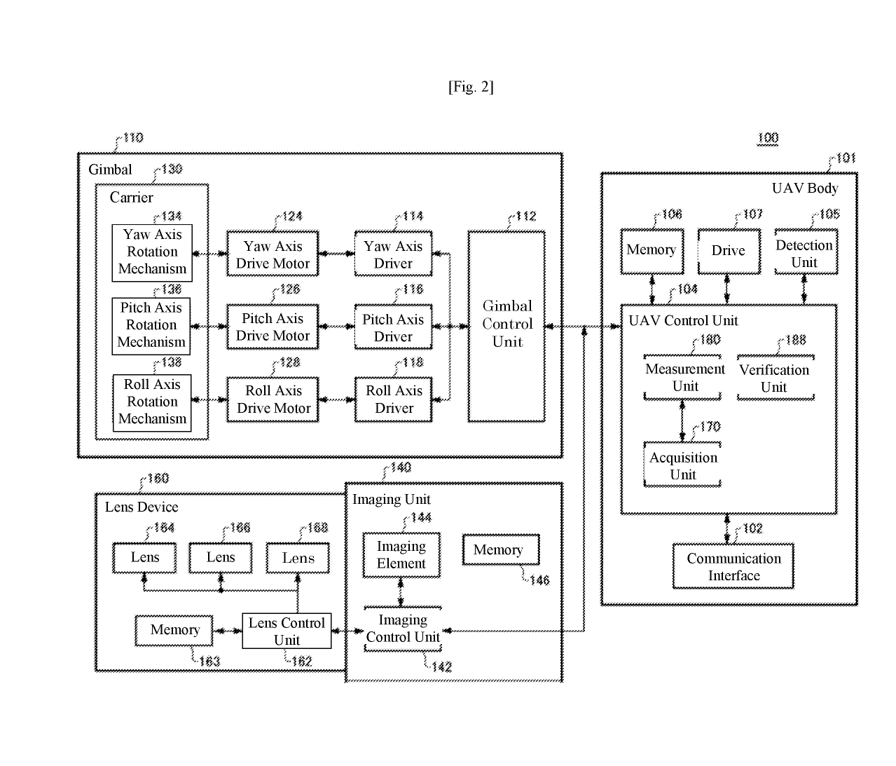

FIG. 2 illustrates a function block of the UAV 100. The UAV 100 can include the UAV body 101, the gimbal 110, and the optical device 190. The UAV body 101 can include a communication interface 102, a UAV control unit 104, a memory 106, a drive unit 107, and a detection unit 105.

The drive unit 107 can be a mechanism for moving the UAV 100. The drive unit 107 can include, for example, a plurality of rotary wings and a plurality of drive motors that drive the plurality of rotary wings. The UAV 100 can fly due to the drive unit 107 driving.

The communication interface 102 can communicate with an external transmitter. The communication interface 102 can receive various commands from a remote transmitter. The UAV control unit 104 can control the flight of the UAV 100 following the commands received from the transmitter. The UAV control unit 104 can control the gimbal 110, the imaging unit 140, and the lens device 160. The UAV control unit 104 can be configured by microprocessors such as CPU or MPU, microcontrollers such as MCU, etc. The memory 106 can store programs etc. necessary for the UAV control unit 104 to control the gimbal 110, the imaging unit 140, and the lens device 160. The memory 106 can be a computer readable recording medium, and can include at least one flash memory such as SRAM, DRAM, EPROM, EEPROM, USB memory etc. The memory 106 can be provided on a housing of the UAV 100, and can be removably provided with the housing of the UAV 100. The UAV control unit 104 and a gimbal control unit 112 can function as a control device of the UAV 100. In such case, a program for adjusting the center of gravity position of an object system including the optical device 190 is read from the memory 106 and executed. The UAV control unit 104 can function as a control device of the UAV 100.

The detection unit 105 can detect the state of the UAV 100 and the state around the UAV 100. The detection unit 105 can detect, for example, a position including the latitude, longitude, and height of the UAV 100, and a heading corresponding to the orientation of the nose of the UAV 100. The detection unit 105 can include an imaging device for sensing that images the surroundings of the UAV 100.

The UAV control unit 104 can include a verification unit 188. The verification unit 188 can execute the initialization of the UAV 100 before flying. The verification unit 188 can execute an operation verification of the drive unit 107 and the detection unit 105. The verification unit 188 can execute the operation verification of the drive unit 107 and the detection unit 105 before the UAV 100 begins to fly. The verification unit 188 can execute an operation verification of various sensors that detect the state of a drive motor that drives the rotary wings and the state of the UAV 100. The period of time in which initialization is executed is an example of the period of time from when power is applied to the UAV 100 until the UAV 100 begins moving.

The gimbal 110 can have the gimbal control unit 112, a yaw axis driver 114, a pitch axis driver 116, a roll axis driver 118, a yaw axis drive motor 124, a pitch axis drive motor 126, a roll axis drive motor 128, and a carrier 130.

The carrier 130 can rotatably support the imaging unit 140 and the lens device 160 with the yaw axis, pitch axis, and roll axis as the center. The carrier 130 can include a yaw axis rotation mechanism 134, a pitch axis rotation mechanism 136 and a roll axis rotation mechanism 138. The yaw axis rotation mechanism 134 can rotate the imaging unit 140 and the lens device 160 using the yaw axis drive motor 124 with the yaw axis as the center. The pitch axis rotation mechanism 136 can rotate the imaging unit 140 and the lens device 160 using the pitch axis drive motor 126 with the pitch axis as the center. The roll axis rotation mechanism 138 can rotate the imaging unit 140 and the lens device 160 using the roll axis drive motor 128 with the roll axis as the center.

The gimbal control unit 112 is an example of a control unit that controls the attitude of the optical device 190. The gimbal control unit 112 can acquire an operation command for the gimbal 110 from the UAV control unit 104. This operation command can include a desired value of the yaw angle, a desired value of the pitch angle, and a desired value of the roll angle. The yaw angle can be the rotational angle of the optical device 190 around the yaw axis. The pitch angle can be the rotational angle of the optical device 190 around the pitch axis. The roll angle can be the rotational angle of the optical device 190 around the roll axis.

The gimbal control unit 112 can output an operation signal to the respective yaw axis driver 114, pitch axis driver 116, and roll axis driver 118 based on the operation command from the UAV control unit 104. The yaw axis driver 114, pitch axis driver 116, and the roll axis driver 118 can drive the yaw axis drive motor 124, pitch axis drive motor 126, and roll axis drive motor 128 following the operation signal. The yaw axis rotation mechanism 134, pitch axis rotation mechanism 136, and roll axis rotation mechanism 138 can rotate, driven by the yaw axis drive motor 124, pitch axis drive motor 126, and roll axis drive motor 128. The attitude of the optical device 190 can be adjusted as a result.

The imaging unit 140 can have an imaging control unit 142, an imaging element 144, and a memory 146. The imaging control unit 142 can be configured by a microprocessor such as CPU and MPU, a microcontroller such as MCU, etc. The imaging control unit 142 can control the imaging unit 140 and the lens device 160 based on an operation command of the imaging unit 140 and the lens device 160 from the UAV control unit 104. The memory 146 can be a computer readable recording medium, and can include at least one flash memory such as SRAM, DRAM, EPROM, EEPROM, USB memory etc. The memory 146 can be provided inside a housing of the imaging unit 140. It can also be removably provided with the housing of the imaging unit 140.

The imaging element 144 can be held in the housing of the imaging unit 140, can generate image data of an optical image formed via the lens device 160, and can output this image data to the imaging control unit 142. The imaging control unit 142 can store the image data output from the imaging element 144 to the memory 146. The imaging control unit 142 can output and store image data to the memory 106 via the UAV control unit 104.

The lens device 160 can have a lens control unit 162, a lens 164, a lens 166 and a lens 168. The lens 164, the lens 166 and the lens 168 can be arranged inside a body tube of the lens device 160. One or all of the lens 164, the lens 166, and the lens 168 can be arranged to be able to move along the optic axis. A lens that can move along the optic axis is one example of a movable lens. The lens control unit 162 moves at least one of the lens 164, lens 166, or lens 168 along the optical axis following the lens operation command from the imaging control unit 142. The lens device 160 can have one lens, or can have a plurality of lenses. The image formed by the lens of the lens device 160 is captured by the imaging unit 140.

An example is described in the present embodiment wherein the UAV 100 can include the UAV control unit 104, the gimbal control unit 112, the imaging control unit 142 and the lens control unit 162. However, one of the control units can execute a process executed in two or three of the UAV control unit 104, the gimbal control unit 112, the imaging control unit 142 and the lens control unit 162. Processes executed in the UAV control unit 104, the gimbal control unit 112, the imaging control unit 142 and the lens control unit 162 can be executed in one control unit.

The acquisition unit 170 can acquire information that indicates at least one of the mass or the center of gravity position of the optical device 190. The gimbal control unit 112 can control the attitude of the optical device 190 based on at least one of the mass or the center of gravity position indicated in the information acquired by the acquisition unit 170. The time period for acquiring information that indicates at least one of the mass or the center of gravity position of the optical device 190 can be within a time period in which the initialization of the UAV 100 can be executed. The acquisition unit 170 can acquire information that indicates at least one of the mass or the center of gravity position of the optical device 190 while the verification unit 188 is executing the operation verification.

The acquisition unit 170 can acquire information that indicates the mass and the center of gravity position of the optical device 190. The gimbal control unit 112 can control the attitude of the optical device 190 based on the mass and the center of gravity position of the optical device 190 indicated in the information obtained by the acquisition unit 170.

The acquisition unit 170 can acquire information that indicates the plurality of center of gravity positions of the optical device 190 corresponding to a plurality of respective positions of a movable lens from among the one or more lens. The plurality of center of gravity positions of the optical device 190 can correspond to respective plurality of focal lengths of the optical device 190. The plurality of center of gravity positions of the optical device 190 can correspond to respective plurality of focus positions of the optical device 190.

The measuring unit 180 measures the center of gravity position of the optical device 190. The acquisition unit 170 acquires information that indicates a first center of gravity position and a second center of gravity position. The first center of gravity position is the center of gravity position of the optical device 190 measured by the measurement unit 180 when the movable lens is in a first position. The second center of gravity position which is the center of gravity position of the optical device 190 measured by the measurement unit 180 when the movable lens is in a second position.

When the movable lens is in the first position, the lens device 160 can be at the telephoto end. That is to say, the focal length of the lens device 160 can be at its greatest length. The lens device 160 can be at the wide angle end when the movable lens is at the second position. That is to say, the focal length of the lens device 160 can be at its shortest length. The measurement unit 180 can measure the center of gravity position of the optical device 190 when the lens device 160 is in each of a plurality of positions between the telephoto end and the wide angle end.

When the movable lens is in the first position, the focus position of the lens device 160 can be at an infinite end. The focus position of the lens device 160 can be at the closest end when the movable lens is in the second position. The measurement unit 180 can measure the center of gravity position of the optical device 190 when the focus position of the lens device 160 is in each of a plurality of focus positions between the infinite end and the closest end.

The optical device 190 can be held with the ability to rotate centrally around a rotational axis. For example, the optical device 190 can be held with the ability to rotate around the respective axes of the yaw axis, pitch axis, and roll axis. The measurement unit 180 can measure a first center of gravity position and second center of gravity position when the rotational angle around the rotational axis of the optical device 190 is at a first angle, and also can measure the first center of gravity position and the second center of gravity position when the rotational angle around the rotational axis of the optical device 190 is at a second angle. For example, the measurement unit 180 can measure the first center of gravity position and second center of gravity position when the rotational angle around the pitch axis of the optical device 190 is at the first angle, and also can measure the first center of gravity position and the second center of gravity position when the rotational angle around the pitch axis of the optical device 190 is at a second angle.

The optical device 190 can be detachable from the UAV body 101. The optical device 190 can be rotatably held with the rotational axis of a direction different from the gravitational direction as the center. The rotational axis of a direction different from the gravitational direction can be the pitch axis. The measurement unit 180 can measure external force applied on the optical device 190 in a first state with the optical device 190 not mounted on the UAV body 101 and a second state with the optical device 190 mounted on the UAV body 101. It can also measure the center of gravity position of the optical device 190 based on the external force in the first state and the external force in the second state.

In the UAV body 101, the memory 106 can associate, and store, information that indicates the center of gravity position of the optical device 190, having been measured by the measurement unit 180, with identification information of the optical device 190. The memory 106 is an example of a storage unit for associating, and storing, information that indicates the center of gravity position of the optical device 190 with identification information of the optical device 190. The acquisition unit 170 can calculate the center of gravity position of the optical device 190 based on the center of gravity position indicated by the center of gravity position information stored in the memory 106 and associate it with identification information of the optical device 190 mounted to the UAV body 101.

A memory 163 can store information that indicates at least one of the mass or the center of gravity position of the optical device 190. The acquisition unit 170 can acquire information that indicates at least one of the mass or the center of gravity position of the optical device 190 from the optical device 190 mounted on the UAV body 101. The memory 163 can store information that indicates an actual measured value of the center of gravity position of the optical device 190. The acquisition unit 170 can acquire information that indicates an actual measured value of the mass and the center of gravity position of the optical device 190 from the optical device 190 mounted on the UAV body 101. When the weight of the optical device 190 is known, the measurement unit 180 can calculate an output value of torque applied on the gimbal 110 in the initial state of the optical device 190. The sum of the weight and the center of gravity position can be equal to the output value of torque. Therefore, the measurement unit 180 can calculate the center of gravity position when the optical device 190 is mounted to the UAV body 101 based on the output value of torque calculated by the measurement unit 180 and the weight of the optical device 190. The initial state of the optical device 190 refers to when the optical device 190 is mounted to the UAV body 101, and when power is applied to the optical device 190.

The memory 163 can store information that indicates the mass and the center of gravity position of the optical device 190. The acquisition unit 170 can acquire information that indicates the mass and the center of gravity position of the optical device 190 from the optical device 190 mounted on the control device. The acquisition unit 170 can acquire information that indicates the center of gravity position of the optical device 190 from the optical device 190 by communicating with the optical device 190 when the optical device 190 is mounted on the UAV body 101.

When the optical device 190 is detachable from the control device, the memory 106 can associate the classification of a plurality of optical devices 190 with identifying classification information and store information that indicates at least one of the mass or the center of gravity position of the optical device 190 of each respective classification. The acquisition unit 170 can acquire information that indicates at least one of the mass or the center of gravity position stored in the memory 106 and associates it with classification information of the optical device 190 mounted on the UAV body 101.

The gimbal control unit 112 can control the attitude of the optical device 190 based on a desired value of the attitude of the optical device 190, a detected value of the attitude of the optical device 190, and the attitude of the optical device 190 estimated based on the information acquired by the acquisition unit 170. The gimbal control unit 112 can control the attitude of the optical device 190 by feedback information based on the detected value of the attitude of the optical device 190, and a feed forward control based on information acquired by the acquisition unit 170.

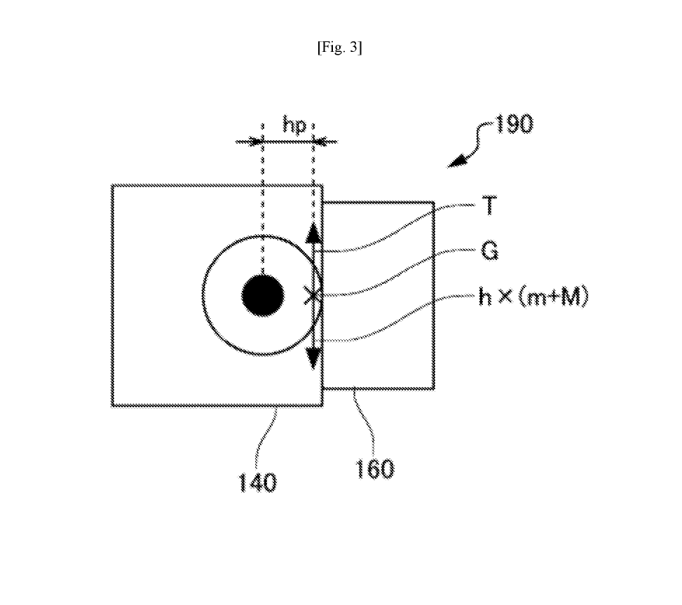

FIG. 3 illustrates when the optical device 190 is held in a reference attitude. As an example, the reference attitude can be such that the optical axis of the lens device 160 is approximately orthogonal to the gravitational direction. A reference attitude can be employed wherein the optical device 190 can be held at a predetermined pitch angle around the pitch axis.

The pitch axis drive motor 126 can generate holding torque T that holds the optical device 190. The holding torque T can be applied to the optical device 190 via a pitch axis rotation mechanism. The optical device 190 can be held in a fixed attitude when the holding torque T balances with torque occurring due to gravity.

Gravity can act on the optical device 190 as an external force. It can be considered that gravity acts at a center of gravity position G of the optical device 190. The size of torque occurring due to gravity can be hp×(m+M) for movement around the pitch axis of the optical device 190. hp can be the distance from the pitch axis to the center of gravity position G. m can be the mass of the imaging unit 140. M can be the mass of the lens device 160. The relational expression T=hp×(m+M) can be fulfilled when the optical device 190 is held in a reference attitude by the holding torque T.

Mass information that indicates the mass M of the lens device 160 can be stored in the memory 163 of the lens device 160. In the imaging unit 140, the imaging control unit 142 can acquire information that indicates the mass M of the lens device 160 from the memory 163. The acquisition unit 170 can communicate with the imaging control unit 142 and can acquire mass information of the lens device 160. Mass information that indicates the mass m of the imaging unit 140 can be stored in the memory 106. The acquisition unit 170 can acquire mass information of the imaging unit 140 from the memory 106. The measurement unit 180 can acquire the holding torque T from the gimbal control unit 112. The measurement unit 180 can calculate a distance h from the pitch axis to the center of gravity position G based on the relational expression relating to the holding torque T, the mass m of the imaging unit 140, and the mass M of the lens device 160.

The measurement unit 180 can measure the holding torque T for holding the optical device 190 in any combination of the zoom value and focus position of the lens device 160. The measurement unit 180 can measure hp for an optional combination of the zoom value and focus position using the measurement of this holding torque T.

The gimbal control unit 112 can calculate a first operation signal based on the difference between a reference input signal and a feedback signal when controlling the pitch axis driver 116. The gimbal control unit 112 can supply an operation signal to the pitch axis driver 116. This operation signal can have a second operation signal added to the first operation signal. The reference input signal can be based on the desired value of the pitch angle. The feedback signal can be based on the detected value of the pitch angle. The second operation signal can be based on hp corresponding to the current zoom value and focus position of the lens device 160, and the mass M+m of the optical device 190. The second operation signal can indicate the attitude of the optical device 190 estimated based on hp and the mass M+m. As a result, the gimbal control unit 112 can control the pitch angle of the optical device 190 by feed forward control based on the center of gravity position of the optical device 190 and the mass of the optical device 190.

The center of gravity position of the optical device 190 can dramatically change if the zoom value and focus position of the lens device 160 change. However, with the feedback control, the pitch angle of the optical device 190 can be suppressed from dramatically changing even if the center of gravity position of the optical device 190 dramatically changes.

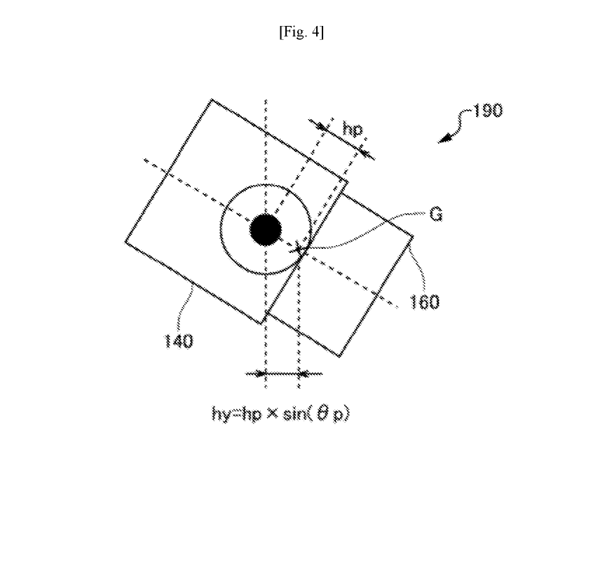

FIG. 4 illustrates a distance hy from the yaw axis to the center of gravity position G. The distance hy is a function of hp and pitch angle θp. The distance hy is expressed as hy=hp×sine (θp). The measurement unit 180 can calculate hy in any θp based on the measured hp.

The gimbal control unit 112 can calculate the first operation signal based on the difference between the reference input signal and the feedback signal when controlling the yaw axis driver 114. The gimbal control unit 112 can supply an operation signal to the pitch axis driver 116. This operation signal can have the second operation signal added to the first operation signal. The reference input signal can be based on the desired value of the yaw angle. The feedback signal can be based on the detected value of the yaw angle. The second operation signal can be based on hy corresponding to the current zoom value and the current focus position of the lens device 160, and the mass M+m of the optical device 190. The second operation signal can indicate the attitude of the optical device 190 estimated based on hy and the mass M+m. As a result, the gimbal control unit 112 can control the yaw angle of the optical device 190 by feed forward control based on the center of gravity position of the optical device 190, the mass of the optical device 190, and the current pitch angle of the optical device 190.

The center of gravity position of the optical device 190 can dramatically change if the zoom value and the focus position of the lens device 160 change. However, with the feedback control, the yaw angle of the optical device 190 can be suppressed from dramatically changing even if the center of gravity position of the optical device 190 dramatically changes.

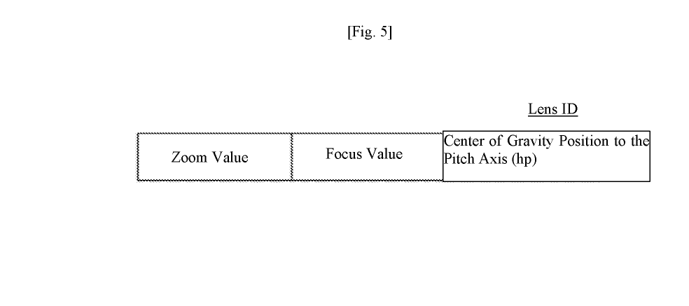

FIG. 5 illustrates a format of first center of gravity position information stored in the memory 106 of the UAV body 101. The first center of gravity position information can include a plurality of groups of zoom values, focus values, and hp data. The memory 106 can associate, and store the first center of gravity position information with a lens ID. The lens ID can be identification information that identifies the lens device 160.

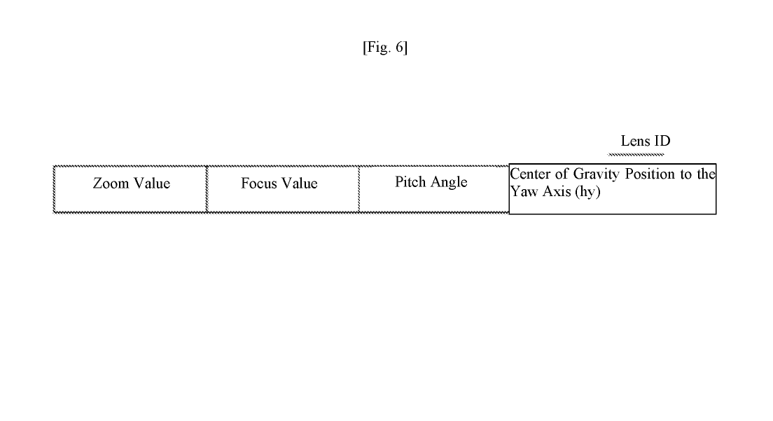

FIG. 6 illustrates a format of second center of gravity position information stored in the memory 106 of the UAV body 101. The second center of gravity position information can include a plurality of groups of zoom values, focus values, pitch angles, and by data. The memory 106 can associate, and store, the second center of gravity position information with a lens ID.

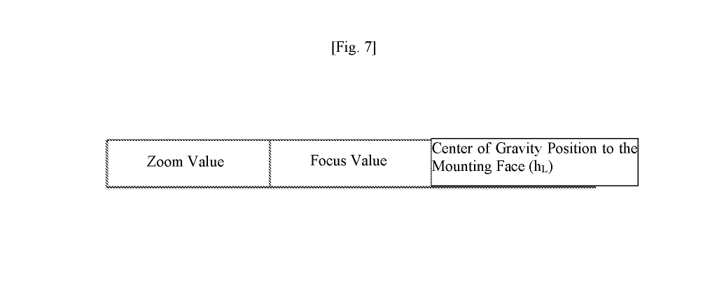

FIG. 7 illustrates a format of third center of gravity position information that indicates a center of gravity position of the lens device 160. The third center of gravity position information can include a plurality of groups of zoom values, focus values, and h_{L} data. h_{L} is, for example, the distance from a mounting face on the lens device 160 to the center of gravity position of the lens device 160. The measurement unit 180 can calculate h_{L} using h_{L}=hp−Lm. Lm can be the distance from the pitch axis to the mounting face on the imaging unit 140.

The UAV control unit 104 can transmit the calculated third center of gravity position information to the lens device 160 via the imaging control unit 142. In the lens device 160, the lens control unit 162 can store this transmitted third center of gravity position information to the memory 163.

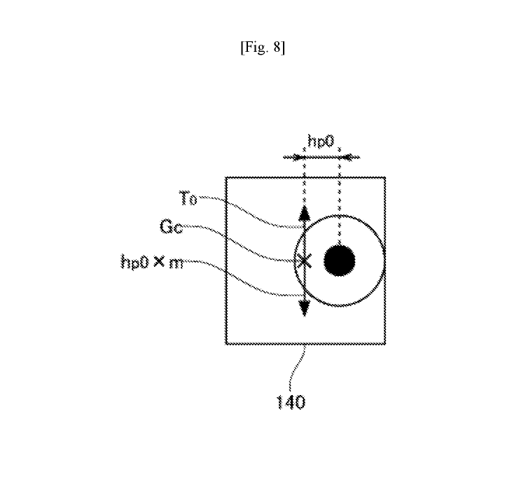

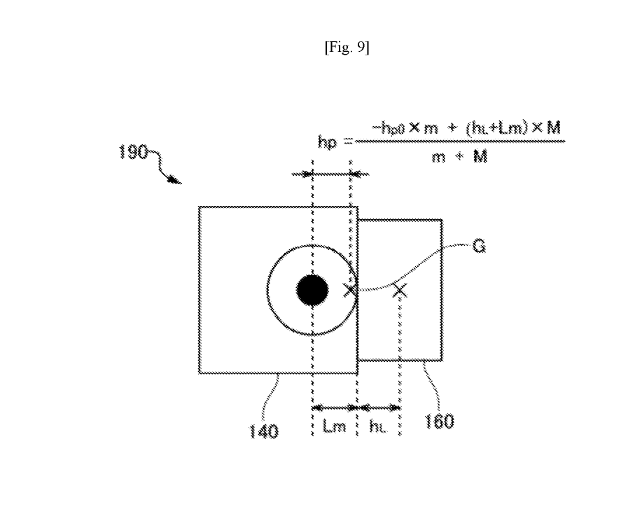

When the third center of gravity position information has been stored in the memory 163, the third center of gravity position information can be then supplied to the UAV control unit 104 via the lens control unit 162 and the imaging control unit 142 if the lens device 160 is mounted on the gimbal 110. The acquisition unit 170 can calculate the center of gravity position of the lens device 160 using the acquired third center of gravity position information. The method for calculating the center of gravity position of the lens device 160 using the third center of gravity position information will be described in relation to FIG. 8 and FIG. 9.

FIG. 8 illustrates when the lens device 160 is not mounted to the imaging unit 140. The measurement unit 180 measures the distance from the pitch axis to the center of gravity position Gc of the imaging unit 140 using a method similar to the measurement method described in relation to FIG. 3.

The measurement unit 180 can acquire a holding torque T₀ from the gimbal control unit 112. This holding torque T₀ can hold the imaging unit 140 in a reference attitude. As illustrated in FIG. 8, the relational expression T₀=hₚ₀×m is fulfilled. The measurement unit 180 can calculate hₚₒ based on the mass m of the imaging unit 140 and the holding torque T₀.

FIG. 9 illustrates a process for calculating hp from the center of gravity position of the lens device 160. The measurement unit 180 can calculate hp using (−hₚ₀×m+(h_{L}+Lm)×M)/(m+M). As a result, the measurement unit 180 can calculate hp and hy corresponding to the plurality of groups of zoom values and focus values using the third center of gravity position information when the third center of gravity position information is stored in the lens device 160. In such a case, the operation for holding the optical device 190 in a reference attitude and acquiring the holding torque T as described in relation to FIG. 3 can be unnecessary.

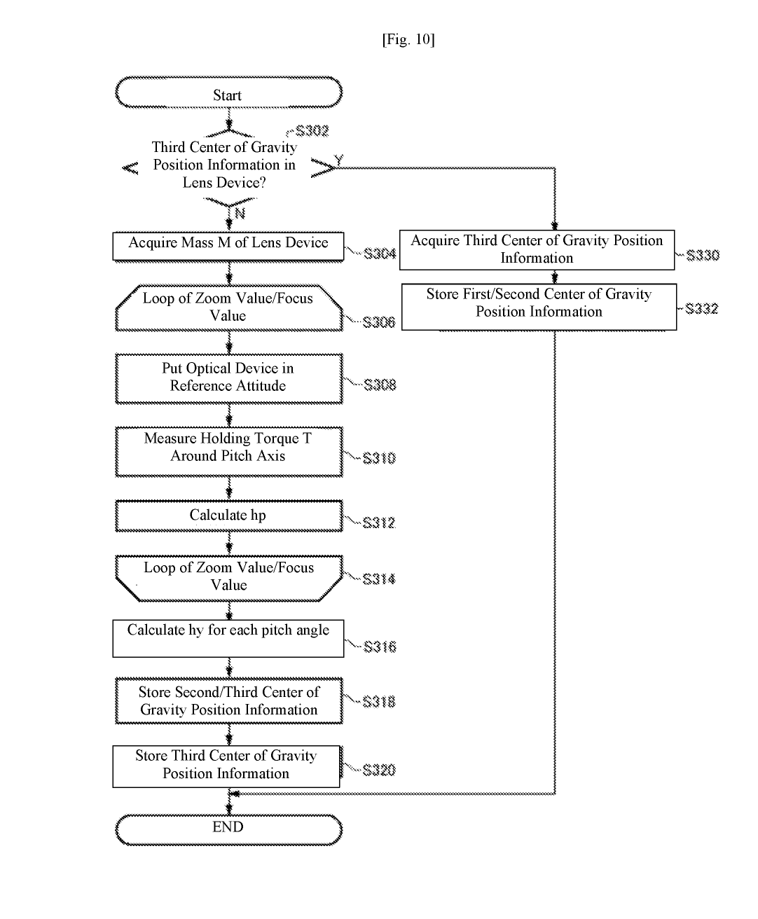

FIG. 10 is a flowchart illustrating center of gravity position measurement procedures, in which hp and hy are measured. The process of this flowchart can be executed in parallel with initialization by the verification unit 188.

At S302, the UAV control unit 104 can determine whether the third center of gravity position information of the lens device 160 is stored in the lens device 160. When the third center of gravity position information is not stored in the lens device 160, the acquisition unit 170 can acquire the mass M of the lens device 160 (S304). The acquisition unit 170 can read the mass M stored in the memory 106 and associate it with a lens ID of the lens device 160.

The process from S306 to S314 can be a loop process relating to a combination of zoom values and focus values of the lens device 160. At S308, the UAV control unit 104 can control the gimbal control unit 112 and hold the optical device 190 at a reference attitude. This reference attitude can be the reference attitude illustrated in FIG. 3. At S310, the measurement unit 180 measures the holding torque T around the pitch axis. At S312, the measurement unit 180 can calculate hp, which indicates the center of gravity position. hp can be then calculated for each of the predetermined plurality of combinations of zoom values and focus values in the loop process from S306 to S314.

At S316, the measurement unit 180 can calculate hy, which indicates the center of gravity position at the pitch angle θp. The method for calculating by can be based on the method described in FIG. 4, etc.

At S318, the UAV control unit 104 can store the first center of gravity position information to the memory 106 and associate it with a combination of zoom values and focus values. The UAV control unit 104 then can store the second center of gravity position information to the memory 106 associating it with a combination of zoom values, focus values, and pitch angles θp.

At S320, the measurement unit 180 can store the third center of gravity position information to the memory 163 of the lens device 160. The operation of this flowchart can be completed when the process at S320 is finished.

At the determination in S302, if the third center of gravity position information can be stored in the memory 163 of the lens device 160, the acquisition unit 170 acquires it from the lens device 160 (S330). The acquisition unit 170 can calculate the first center of gravity position information and the second center of gravity position information and store them to the memory 106 (S332). The operation of this flowchart can be completed when the process at S332 is finished.

With the UAV 100, it is possible to control the attitude of the optical device 190 based on the actual measured value of the center of gravity position of the optical device 190. As a result, control can be performed while considering individual differences between the lens device 160 and the imaging unit 140.

The third center of gravity position information measured in the UAV 100 can be stored in the memory 163 of the lens device 160. In a modified example, the third center of gravity position information can be information measured when manufacturing the lens device 160.

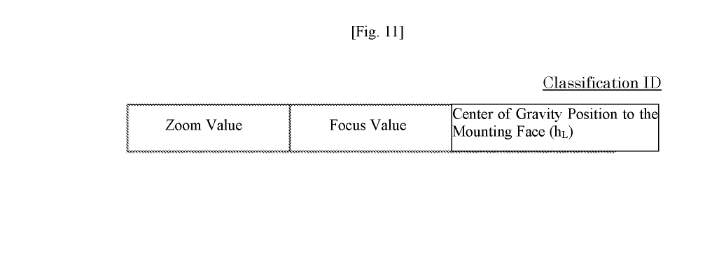

FIG. 11 illustrates a format of fourth center of gravity position information stored in the UAV body 101 in another form. The memory 106 can store center of gravity position information including a plurality of groups of zoom value, focus value, and h_{L} data. The zoom values, focus values, and h_{L} can be all information similar to the third center of gravity position information described in relation to FIG. 7, etc. The fourth center of gravity position information can be center of gravity position information and associate it with the lens classification. In this aspect, the fourth center of gravity position information can differ from the third center of gravity position information. The fourth center of gravity position information can be information written to the memory 106 when the UAV 100 is manufactured. The memory 106 can store the fourth center of gravity position information and associate it with a classification ID that identifies the lens classification of the lens device 160.

When the lens device 160 is mounted to the imaging unit 140, the acquisition unit 170 can acquire the classification ID that identifies the classification of the lens device 160 from the lens device 160. The acquisition unit 170 can acquire the fourth center of gravity position information stored in the memory 106 and associate it with the classification ID. The acquisition unit 170 can calculate the center of gravity position of the optical device 190 using the fourth center of gravity position information. The center of gravity position of the optical device 190 can be calculated using a process similar to the process described in relation to FIG. 7 to FIG. 9.

The lens device 160 can be an interchangeable lens. However, the lens device 160 can be integrally provided with the imaging unit 140. In such a case, the optical device 190 including the lens device 160 and the imaging unit 140 can be detachable from the gimbal 110.

At least one step of the plurality of steps shown can be implemented by hardware or a program commanding related hardware. The program can be stored in a computer readable recording medium. The recording medium can include at least one of a ROM, magnetic disk, or optical disk.

The present disclosure was described using embodiments, but the technical scope of the disclosure is not limited to the scope in the above embodiments. It should be clear to a person skilled in the art that the above embodiments are susceptible to various modifications or improvements. It should also be clear from the scope of the claims that forms having such modifications or improvements can be included in the technical scope of the present disclosure.

The order of each process in the operations, procedures, steps, stages, etc., of the devices, systems, programs, and methods in the scope of the claims, specification, and drawings is not specifically disclosed using “beforehand”, “in advance”, etc., and any order is possible as long as a postprocess does not use the output of a preprocess. Even if “first,” “next”, etc., are used for convenience in describing the flow of operations in the scope of the claims, specification and drawings, it does not mean that it must be executed in this order. “Orthogonal” can also be “intersecting”.

### DESCRIPTION OF REFERENCE NUMERALS

100 UAV
101 UAV body
102 Communication interface
104 UAV control unit
105 Detection unit
106 Memory
107 Drive unit
108 Rotary wings
110 Gimbal
112 Gimbal control unit
114 Yaw axis driver
116 Pitch axis driver
118 Roll axis driver
124 Yaw axis drive motor
126 Pitch axis drive motor
128 Roll axis drive motor
130 Carrier
134 Yaw axis rotation mechanism
136 Pitch axis rotation mechanism
138 Roll axis rotation mechanism
140 Imaging unit
164 Lens
190 Optical device

1. A control device, comprising:
an acquisition unit for acquiring information that indicates at least one of a mass or a center of gravity position of an optical device having one or more lens; and
a control unit for controlling an attitude of the optical device based on the at least one of the mass or the center of gravity position indicated in the information acquired by the acquisition unit.

2. The control device of claim 1, wherein:
the acquisition unit acquires information that indicates the mass and the center of gravity position of the optical device; and
the control device controls the attitude of the optical device based on the mass and the center of gravity position of the optical device indicated in the information acquired by the acquisition unit.

3. The control device of claim 2, wherein the acquisition unit acquires information that indicates a plurality of center of gravity positions of the optical device, corresponding to a plurality of respective positions of a movable lens from among the one or more lens.

4. The control device of claim 3, wherein the plurality of center of gravity positions of the optical device corresponds to a plurality of respective focal distances of the optical device.

5. The control device of claim 3, wherein the plurality of center of gravity positions of the optical device corresponds to a plurality of respective focus positions of the optical device.

6. The control device of claim 3, further comprising:
a measurement unit for measuring the center of gravity positions of the optical device, wherein the acquisition unit acquires information that indicates:
a first center of gravity position of the optical device measured by the measurement unit when the movable lens is in a first position, and
a second center of gravity position of the optical device measured by the measurement unit when the movable lens is in a second position.

7. The control device of claim 6, wherein:
the optical device is rotatably held with a rotational axis as a center; and
the measurement unit measures the first center of gravity position and the second center of gravity position when a rotation angle around the rotational axis of the optical device is at a first angle, and measures the first center of gravity position and the second center of gravity position when the rotation angle around the rotational axis of the optical device is at a second angle.

8. The control device of claim 6, wherein:
the optical device is detachable from the control device;
the optical device is configured to be rotatably held with the rotational axis of a direction different from a gravitational direction as a center; and
the measurement unit measures external force applied on the optical device in a first state with the optical device not mounted on the control device and a second state with the optical device mounted on the control device, and measures the center of gravity position of the optical device based on the external force in the first state and the external force in the second state.

9. The control device of claim 6, wherein:
the optical device is detachable from the control device;
the control device further comprises a storage unit for storing center of gravity position information that indicates the center of gravity position of the optical device measured by the measurement unit and associating it with identification information of the optical device; and
the acquisition unit calculates the center of gravity position of the optical device based on the center of gravity position indicated by the center of gravity position information stored in the storage unit, and associates the center of gravity position of the optical device with the identification information of the optical device mounted to the control device.

10. The control device of claim 1, wherein:
the optical device is detachable from the control device;
the optical device has a storage unit for storing the information that indicates the at least one of the mass or the center of gravity position of the optical device; and
the acquisition unit acquires the information that indicates the at least one of the mass or the center of gravity position of the optical device from the optical device mounted on the control device.

11. The control device of claim 10, wherein:
the storage unit stores information that indicates an actual measured value of the center of gravity position of the optical device; and
the acquisition unit acquires information that indicates an actual measured value of the mass and the information that indicates the actual measured value of the center of gravity position of the optical device from the optical device mounted on the control device.

12. The control device of claim 10, wherein:
the storage unit stores information that indicates the mass and the center of gravity position of the optical device; and
the acquisition unit acquires the information that indicates the mass and the center of gravity position of the optical device from the optical device mounted on the control device.

13. The control device of claim 10, wherein the acquisition unit acquires information that indicates the center of gravity position of the optical device from the optical device by communicating with the optical device when the optical device is mounted on the control device.

14. The control device of claim 1, wherein:
the optical device is detachable from the control device;
the control device further comprises a storage unit for associating classifications of a plurality of optical devices with identifying classification information and storing information that indicates the at least one of the mass or the center of gravity position of optical devices of each respective classification; and
the acquisition unit acquires the information that indicates the at least one of the mass or the center of gravity position stored in the storage unit and associates the information that indicates the at least one of the mass or the center of gravity position with classification information of the optical device mounted on the control device.

15. The control device of claim 1, wherein the control unit controls the attitude of the optical device based on a desired value of the attitude of the optical device, a detected value of the attitude of the optical device, and the attitude of the optical device estimated based on the information acquired by the acquisition unit.

16. The control device of claim 1, wherein the optical device further includes an imaging unit for capturing an image formed by the one or more lens.

17. An imaging device, comprising:
the control device of claim 1; and
an imaging unit for capturing an image formed by the one or more lens.

18. The imaging device of claim 17, wherein the one or more lens are included in an interchangeable lens that is detachable from the imaging unit.

19. A mobile object comprising the control device of claim 1, wherein the acquisition unit acquires the information that indicates the at least one of the mass or the center of gravity position of the optical device during a period from a time when power is applied to the mobile object until a time when the mobile object begins moving.

20. The mobile object of claim 19, further comprising:
a drive unit for moving the mobile object;
a detection unit for detecting a state of the mobile object or a state around the mobile object; and
a verification unit for executing an operation verification of the drive unit and detection unit,
wherein the acquisition unit acquires the information that indicates the at least one of the mass or the center of gravity position of the optical device while the verification unit executes the operation verification.
